(19) United States
(12) Patent Application Publication
(10) Pub. No.: US 2026/0111222 A1
(43) Pub. Date: Apr. 23, 2026

(54) HIERARCHICAL GRAPH NEURAL NETWORK FOR CROSS-ARCHITECTURAL SOFTWARE REVERSE ENGINEERING

(71) Applicants: SIEMENS CORPORATION, Washington, DC (US); THE REGENTS OF THE UNIVERSITY OF CALIFORNIA, Berkeley, CA (US)

(72) Inventors: Shih-Yuan Yu, Irvine, CA (US); Yonatan Gizachew Achamyeleh, Irvine, CA (US); Chonghan Wang, Davis, CA (US); Anton Kocheturov, Langhorne, PA (US); Patrick Eisen, Princeton, NJ (US); Mohammad Abdullah Al Faruque, Irvine, CA (US)

(73) Assignees: Siemens Aktiengesellschaft, Munich (DE); THE REGENTS OF THE UNIVERSITY OF CALIFORNIA, Berkeley, CA (US)

(21) Appl. No.: 19/118,004

(22) PCT Filed: Aug. 16, 2023
(86) PCT No.: PCT/US2023/030306

§ 371 Date: Apr. 3, 2025

Related U.S. Application Data
(60) Provisional application No. 63/378,532, filed on Oct. 6, 2022.

(51) Int. Cl. G06F 8/74; G06F 8/53; G06N 3/0464

(52) U.S. Cl. CPC G06F 8/74; G06F 8/53; G06N 3/0464

(57) ABSTRACT

Recovering symbols from a stripped binary includes representing the stripped binary as a plurality of graph of graphs (GoG) representations, converting the plurality of GoGs into a plurality of expressive representations of each function in the stripped binary, training a machine learning (ML) model using the expressive representations, and determining a missing symbol of at least one of the functions based on an output of the ML model. Information relating to functions is and interactions between functions are used to train an ML to determine similarity of two functions. Based on similarities, missing symbols may be inferred and used to enable updates to the stripped binary file where source code is not available.

### TECHNICAL FIELD

This application relates to software development. More particularly, this application relates to reverse engineering of binary representations of software source code.

### BACKGROUND

Periodically, software requires updating to address ongoing concerns including security vulnerabilities that may be discovered over time. Typically, to address vulnerabilities, vendors offer patches in the form of source code changes based on the current software version (e.g., version 0.9). However, in legacy systems the only available data is binary files based on corresponding source code (e.g., version 0.1). Such a version gap introduces challenges in applying patches to the legacy binaries, leaving the only solution for applying patches to legacy software as direct binary analysis. Reverse Engineers (REs) must leverage Software Reverse Engineering (SRE) tools such as Ghidra, HexRays, and radare2 to first disassemble and decompile binaries into higher-level representations (e.g., C or C++). Typically, these tools take the debugging information, strings, and the symbol-table in binary to reconstruct function names and variable names. This allows REs to reconstruct a software's structure and functionality without access to source code. For REs, these symbols encode the context of the source code and provide invaluable information for their tasks. Next, REs must understand the program's logic to be achieve their objectives of patching vulnerable binaries. However, to optimize the binary's footprint in mission-critical legacy systems where memory is limited, symbols are often excluded to reduce the binary file size. Because recovering symbols from stripped binaries is not straightforward, most decompilers assign meaningless symbol names to coding elements. In order to understand the software semantics, REs need to leverage their experience and expertise to consume the information then interpret the semantics of each coding element. Improved methods for determining missing symbols in a binary file are desired.

### SUMMARY

A method for recovering symbols from a stripped binary according to embodiments of this disclosure includes representing the stripped binary as a plurality of graph of graphs (GoG) representations, converting the plurality of GoGs into a plurality of expressive representations of each function in the stripped binary, training a machine learning (ML) model using the expressive representations, and determining a missing symbol of at least one of the functions based on an output of the ML model. The stripped binary is represented as a plurality of GoGs further by using a decompiler to export P-code and cross calling dependencies for each function contained in the stripped binary and decompiling each function to extract the function's basic blocks, summarizing attributes, and corresponding P-code. Using this information, each function may be represented as a graph of basic blocks and creating a GoG for all functions in the stripped binary, wherein nodes contain a graph of basic blocks of a function, and edges represent relationships between functions based on the cross-calling dependencies.

According to embodiments, converting the plurality of GoGs into a plurality of expressive representations may be performed by inputting the plurality of GoGs to a hierarchical graph learning pipeline comprising a control flow graph (CFG) embedding layer and a GoG embedding layer to produce the expressive representations. The hierarchical graph learning pipeline includes performing the steps of in the CFG embedding layer, using one or more graph convolutional network (GCN) layers to propagate features for each basic block of a function to produce an aggregated vectorized representation, and in the GoG embedding layer, receiving the aggregated vectorized representation, incorporating calling and callee functions information into each function to produce the expressive representation of each function. Training the ML model using the expressive representations of the functions may be achieved via a contrastive function similarity learning process. If the expressive representation of two functions indicate that the two functions behave similarly, a missing symbol of one of the functions in the stripped binary is determined based on the function's embeddings. Each of the two functions may be built from different CPU architectures. According to one embodiment, the decompiler is a Ghidra decompiler. In some embodiments, the hierarchical graph learning pipeline may be implemented as a data toolkit for a Ghidra reverse engineering tool using Application Programming Interfaces (APIs) of the Ghidra reverse engineering tool. A software update of the stripped binary may be performed based in part of the discovered missing symbol.

A system for recovering symbols from a stripped binary includes a computer processor in communication with a non-transitory computer memory, the non-transitory computer memory storing machine readable instructions that when executed by the computer processor cause the computer processor to represent the stripped binary as a plurality of graph of graphs (GoG) representations, convert the plurality of GoGs into a plurality of expressive representations of each function in the stripped binary, train a machine learning (ML) model using the expressive representations, and determine a missing symbol of at least one of the functions based on an output of the ML model. The stripped binary may be represented as a plurality of GoGs using a decompiler and exporting P-code and cross calling dependencies for each function contained in the stripped binary. Each function may be further decompiled to extract the function's basic blocks, summarizing attributes, and corresponding P-code representing each function as a graph of basic blocks, then creating a GoG for all functions in the stripped binary, wherein nodes of the GoG contain a graph of basic blocks of a function, and edges represent relationships between functions based on the cross-calling dependencies.

Converting the plurality of GoGs into a plurality of expressive representations is performed by inputting the plurality of GoGs to a hierarchical graph learning pipeline comprising a control flow graph (CFG) embedding layer and a GoG embedding layer to produce the expressive representations. The hierarchical graph learning pipeline further performs in the CFG embedding layer, using one or more graph convolutional network (GCN) layers to propagate features for each basic block of a function to produce an aggregated vectorized representation. In the GoG embedding layer, the aggregated vectorized representations are received and calling and callee functions information is incorporated into each function to produce the expressive representation of each function. Embodiments may include systems that further train the ML model using the expressive the expressive representation of two functions indicate that the two functions behave similarly, a missing symbol of one of the functions based on the function's embeddings may be determined. A software update of the stripped binary may be performed based in part of the discovered missing symbol.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

### DETAILED DESCRIPTION

In mission-critical systems, embedded software is vital in manipulating physical processes and executing missions that could pose risks to human operators. Recently, the concept of the Internet of Things (IoT) has become increasingly popular, creating a market valued at 19 trillion dollars and drastically increasing the number of connected devices to approximately 35 billion in 2025. However, while IoT brings technological growth, it unintendedly exposes mission-critical systems, especially legacy systems, to novel vulnerabilities. The reported number of IoT cyberattacks increased 300% in 2019, while the discovered software vulnerabilities rose from 1.6k to 100k. For example, the Heartbleed bug can leak up to 64K memory, threatening personal and organizational information security. Shellshock is a bash command-line interface shell bug, but it has existed for 30 years and remains a threat to enterprises today. For these mission-critical systems, unexpected disruptions can incur millions of dollars in lost revenues, even if they only last for a few hours or minutes. While timely patching these vulnerabilities and applying updates to the impacted software seems straightforward, in reality, mission-critical systems typically employ software used for decades because of mission criticality or the high cost of updating. Over time, along with technological advancements, the software in these systems becomes legacy, and the number of newly discovered vulnerabilities may increase. The original development environment, maintenance support, or source code may no longer exist or be available for legacy software.

Typically, to address vulnerabilities, vendors offer patches in the form of source code changes based on the current software version (e.g., version 0.9). However, the only available data in the legacy system is binary based on its source code (e.g., version 0.1). Such a version gap poses challenges in applying patches to the legacy binaries, leaving the only solution for applying patches to legacy software as direct binary analysis. Today, REs must leverage Software Reverse Engineering (SRE) tools such as Ghidra, HexRays, and radare2 to first disassemble and decompile binaries into higher-level representations (e.g., C or C++). Typically, these tools take the debugging information, strings, and the symbol-table and binary to reconstruct function names and variable names, allowing REs to reconstruct a software's structure and functionality without access to source code. For REs, these symbols encode the context of the source code and provide invaluable information for their tasks. Next, REs must understand the program's logic to achieve their objectives of patching vulnerable binaries. However, to optimize the binary's footprint in mission-critical legacy systems where memory is limited, symbols are often excluded to reduce the binary file size. Because recovering symbols from stripped binaries is not straightforward, most decompilers assign meaningless symbol names to coding elements. In order to understand the software semantics, REs must leverage their experience and expertise to consume the information then interpret the semantics of each coding element.

Software Reverse Engineering (SRE) aims to understand program behaviors without access to the source code, often used in many applications such as malware detection, discovering vulnerabilities, and patching bugs in legacy software. One of the primary tools that Reverse Engineers (REs) use to inspect programs is the disassembler, which is a tool that translates a binary program into low-level assembly code. Examples of such tools include GNU Binutils objdump, IDA, Binary Ninja, and Hopper. However, reasoning at the assembly level requires considerable cognitive effort from RE experts, even with the aid of these tools. More recently, REs use decompilers such as Hex-Rays, or Ghidra to reverse the compiling process by further translating the output of disassemblers into the code that resembles high-level programming languages such as C or C++ reducing the burden of understanding assembly code. These decompilers may use program analysis and heuristics to reconstruct a binary's variables, types, functions, and control flow structure. However, the decompilation is incomplete despite these decompilers generating a higher-level output for better code understanding. This is due to the fact that the compilation process discards the source-level information and lowers its abstraction level in exchange for a smaller footprint size, faster execution time, or even security considerations. Accordingly, source-level information including comments, variable names, function names, and idiomatic structure may be essential for understanding a program but is typically unavailable in the output of these decompilers.

Analyzing a software binary to eliminate vulnerabilities is straightforward and effective for enhancing security, as developers usually deploy their software in binaries. Usually, security experts can conduct their patching process or vulnerability analysis by understanding the compilation source, function signatures, and variable information. However, after compilation, such information is usually stripped or obfuscated deliberately. In this case, analyzing stripped binaries becomes more challenging. The early recovery work for binaries focuses on manual completion but suffers from low efficiency, high cost, and the error-prone nature of reverse engineering. The increase in computing power has pushed researchers to tackle this challenge using Machine Learning (ML) methodologies. As ML has significantly advanced in its reasoning capability, researchers in this field first leverage the general information from each function for in-depth binary code understanding and reconstructing higher-level source code information as an alternative to manual-based approaches. A first approach used neural network-based and graph-based models. It predicted the function types to assist the reverse engineer in understanding the binary. Another approach predicted function names using neural networks. It aggregated the related features of sections of binary vectors. Then the binary will consist of feature vectors that are ready for training. It subsequently analyzes the connections between each part of the code with the Natural Language Processing (NLP) to predict the function name. On the other hand, this method does not use a neural network. It combines a decision-tree-based classification algorithm and a structured prediction with a probabilistic graphical model. Then by analyzing symbol names, types, and locations to match the function name.

Embodiments described here present a novel methodology including two main contributions to the software reverse engineering tooling domain. These contributions will be discussed in detail in the following paragraphs.

The first object of the disclosed embodiments models a stripped binary executable as a graph-of-graph (GoG) representation. This step converts stripped binaries to a dual-layered graph, denoted as a Graph-of-Graph representation. Starting from a stripped binary the state-of-the-art decompiler, Ghidra, and its Ghidra Headless Analyzer are leveraged to develop a novel Ghidra Data Toolkit (GDT) tool. The GDT is a Java-based metadata extracting script for implementing these tools. GDT incorporates the APIs of Ghidra to export the decompiled P-code information for each function and their cross-calling dependencies. For each decompiled binary function, GDT also decompiles it into basic blocks and their control-flow dependencies, extracting their summarizing attributes and corresponding P-code. Lastly, GDT integrates all the information and forms a GoG representation for the given stripped binary.

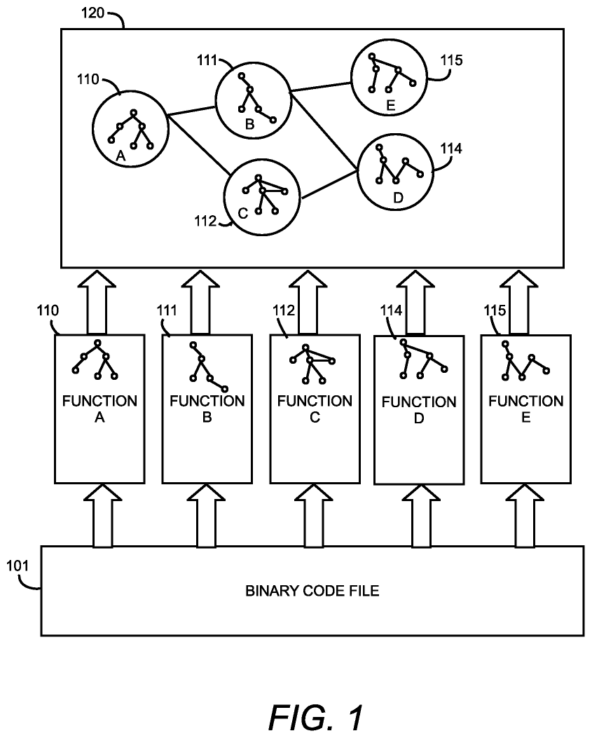

FIG. 1 is a flow diagram showing the generation of a GoG from a compiled binary according to embodiments of this disclosure. A binary code file 101 is decompiled into blocks such as functions performed by the binary file 101. Each function may be characterized as a graph 110, 111, 112, 113, 114, 115, based on the actions of the function and the dependencies of the functions. Control flow between functions may be used to determine relations between functions and arranged in a graph of graphs 120.

In a second object, embodiments of this disclosure use hierarchical graph learning techniques to model GoG representations in order to reconstruct function names for each binary function. Hierarchical graph learning techniques may be used to model complex GoG representations and perform reconstruction of function names to improve on state-of-the-art decompilers (e.g., Ghidra) and provide more source-level information for reverse engineers.

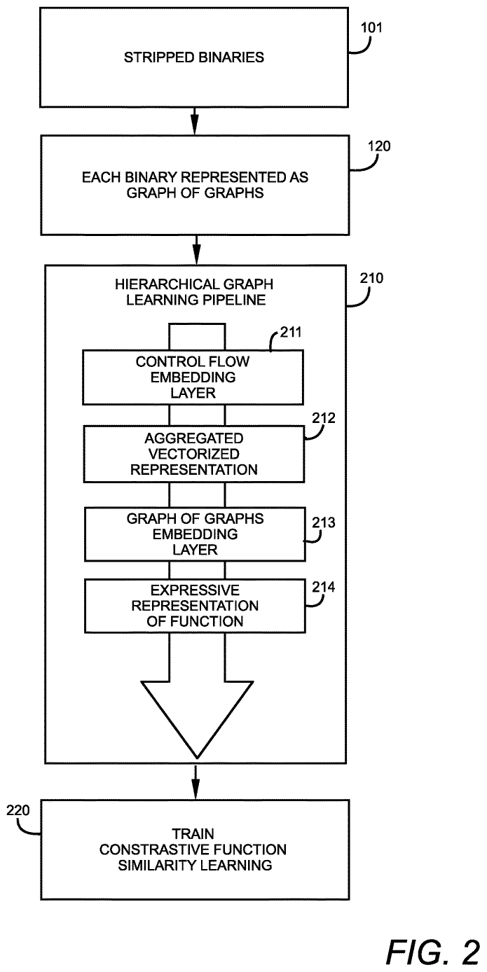

FIG. 2 is a block diagram illustrating the training of a hierarchical graph model according to embodiments of this disclosure. To conduct the model training, once the GDT converts all the stripped binaries into GoGs as depicted in FIG. 1, the GoGs 120 are input into a hierarchical graph learning pipeline 210, including a control flow graph (CFG) embedding layer 211 and a GoG embedding layer 213. The CFG embedding layer 211 includes one or multiple Graph Convolutional Network (GCN) layers that propagate the information for each basic block (e.g., attributes+P-code) and generates an aggregated vectorized representation 212 for each function (e.g., function embeddings) utilizing control-flow level information. The GoG embedding layer 213 further processes these function embeddings, including another graph convolutional layer to propagate information from each function incorporating the information of calling or callee functions into each function, creating the expressive representation of each function 214. Then, we used these resulting representations 214 of functions to train all the layers using the contrastive function similarity learning process 220. Specifically, the design allows the model to learn if two binary functions behave similarly, meaning even if they are built from different CPU architectures their function embeddings should be as similar as possible.

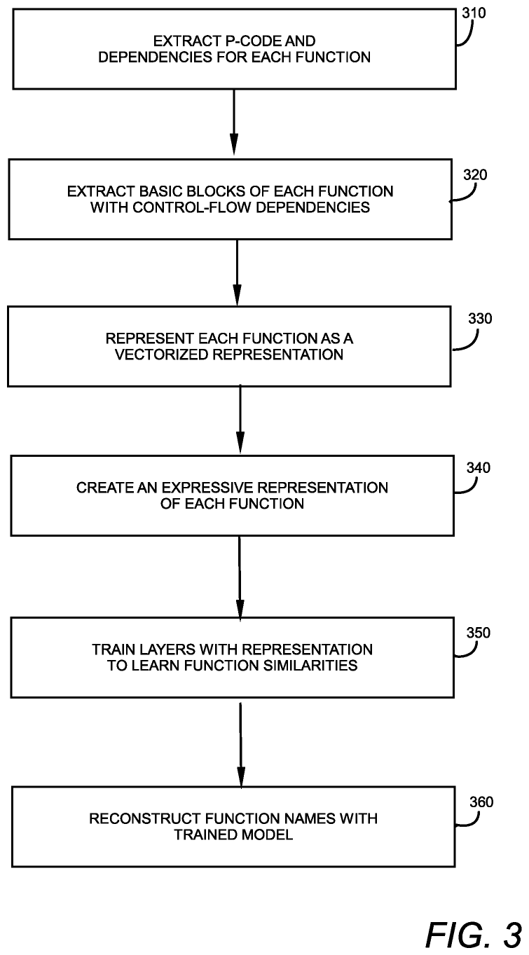

FIG. 3 is a process flow diagram for a method of reconstructing missing information from a compiled binary file according to aspects of embodiments of this disclosure. From the binary file, the p-code and dependencies for each function in the binary are extracted 310. From each function extracted, the basic blocks of each function (e.g., if statements, or iterative loops, etc.) are extracted along with the basic control flow dependencies of the blocks 320. Each function may be numerically characterized and represented as a vectorized representation 330. By comparing the relations between functions, each function is further processed using graph convolutional layers to create an expressive representation of each function 340. These representations are used to train the graph learning pipeline to learn similarities between various function 350. These similarities between functions may be further utilized to determine the names of the functions using the trained model. 360.

Embodiments of this disclosure provide improvements of manual analysis of binary files to allow REs to more efficiently and automatically extract missing information relating to source code files from their corresponding compiled binaries.

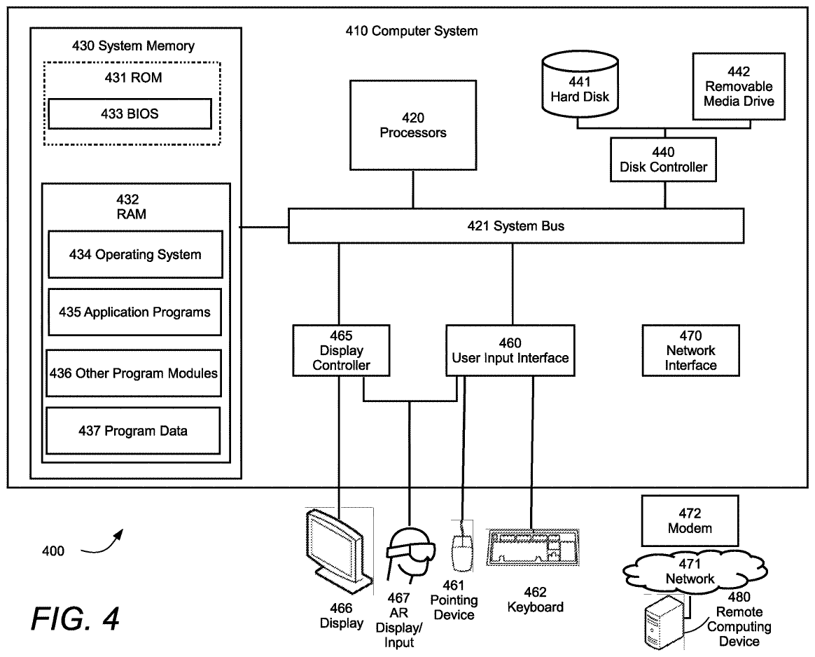

FIG. 4 illustrates an exemplary computing environment 400 within which embodiments of the invention may be implemented. Computers and computing environments, such as computer system 410 and computing environment 400, are known to those of skill in the art and thus are described briefly here.

As shown in FIG. 4, the computer system 410 may include a communication mechanism such as a system bus 421 or other communication mechanism for communicating information within the computer system 410. The computer system 410 further includes one or more processors 420 coupled with the system bus 421 for processing the information.

The processors 420 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 4, the computer system 410 also includes a system memory 430 coupled to the system bus 421 for storing information and instructions to be executed by processors 420. The system memory 430 may include computer readable storage media in the form of volatile and/or nonvolatile memory, such as read only memory (ROM) 431 and/or random-access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, other program modules 436 and program data 437.

The computer system 410 also includes a disk controller 440 coupled to the system bus 421 to control one or more storage devices for storing information and instructions, such as a magnetic hard disk 441 and a removable media drive 442 (e.g., floppy disk drive, compact disc drive, tape drive, and/or solid-state drive). Storage devices may be added to the computer system 410 using an appropriate device interface (e.g., a small computer system interface (SCSI), integrated device electronics (IDE), Universal Serial Bus (USB), or FireWire).

The computer system 410 may also include a display controller 465 coupled to the system bus 421 to control a display or monitor 466, such as a cathode ray tube (CRT) or liquid crystal display (LCD), for displaying information to a computer user. The computer system includes an input interface 460 and one or more input devices, such as a keyboard 462 and a pointing device 461, for interacting with a computer user and providing information to the processors 420. The pointing device 461, for example, may be a mouse, a light pen, a trackball, or a pointing stick for communicating direction information and command selections to the processors 420 and for controlling cursor movement on the display 466. The display 466 may provide a touch screen interface which allows input to supplement or replace the communication of direction information and command selections by the pointing device 461. In some embodiments, an augmented reality device 467 that is wearable by a user, may provide input/output functionality allowing a user to interact with both a physical and virtual world. The augmented reality device 467 is in communication with the display controller 465 and the user input interface 460 allowing a user to interact with virtual items generated in the augmented reality device 467 by the display controller 465. The user may also provide gestures that are detected by the augmented reality device 467 and transmitted to the user input interface 460 as input signals.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium, such as a magnetic hard disk 441 or a removable media drive 442. The magnetic hard disk 441 may contain one or more datastores and data files used by embodiments of the present invention. Datastore contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

The computing environment 400 may further include the computer system 410 operating in a networked environment using logical connections to one or more remote computers, such as remote computing device 480. Remote computing device 480 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention.

What is claimed is:

1. A method for recovering symbols from a stripped binary comprising:
representing the stripped binary as a plurality of graph of graphs (GoG) representations;
converting the plurality of GoGs into a plurality of expressive representations of each function in the stripped binary;
training a machine learning (ML) model using the expressive representations; and
determining a missing symbol of at least one of the functions based on an output of the ML model.

2. The method of claim 1, wherein representing the stripped binary as a plurality of GoGs further comprises:
using a decompiler, export a P-code and cross calling dependencies for each function contained in the stripped binary;
further decompiling each function to extract the function's basic blocks, summarizing attributes, and corresponding P-code;
representing each function as a graph of basic blocks; and
creating a GoG for all functions in the stripped binary, wherein nodes contain a graph of basic blocks of a function, and edges represent relationships between functions based on the cross-calling dependencies.

3. The method of claim 1, wherein converting the plurality of GoGs into a plurality of expressive representations comprises:
inputting the plurality of GoGs to a hierarchical graph learning pipeline comprising a control flow graph (CFG) embedding layer and a GoG embedding layer to produce the expressive representations.

4. The method of claim 3, the hierarchical graph learning pipeline further performing the steps of:
in the CFG embedding layer, using one or more graph convolutional network (GCN) layers to propagate features for each basic block of a function to produce an aggregated vectorized representation; and
in the GoG embedding layer, receiving the aggregated vectorized representation, incorporating calling and callee functions information into each function to produce the expressive representation of each function.

5. The method of claim 4, further comprising:
training the ML model using the expressive representations of the functions in a contrastive function similarity learning process.

6. The method of claim 5, further comprising:
on a condition that the expressive representation of two functions indicate that the two functions behave similarly, determining a missing symbol of one of the functions based on the function's embeddings.

7. The method of claim 6, wherein each of the two functions are built from different CPU architectures.

8. The method of claim 2, wherein the decompiler is a Ghidra decompiler.

9. The method of claim 3, further comprising implementing the hierarchical graph learning pipeline as a data toolkit for a Ghidra reverse engineering tool.

10. The method of claim 9, wherein the data toolkit incorporates the Application Programming Interfaces (APIs) of the Ghidra reverse engineering tool.

11. The method of claim 1, further comprising:
performing a software update of the stripped binary based in part of the discovered missing symbol.

12. A system for recovering symbols from a stripped binary comprising:
a computer processor in communication with a non-transitory computer memory, the non-transitory computer memory storing machine readable instructions that when executed by the computer processor cause the computer processor to:
represent the stripped binary as a plurality of graph of graphs (GoG) representations;
convert the plurality of GoGs into a plurality of expressive representations of each function in the stripped binary;
train a machine learning (ML) model using the expressive representations; and
determine a missing symbol of at least one of the functions based on an output of the ML model.

13. The system of claim 12, wherein representing the stripped binary as a plurality of GoGs further comprises:
using a decompiler, export a P-code and cross calling dependencies for each function contained in the stripped binary;
further decompiling each function to extract the function's basic blocks, summarizing attributes, and corresponding P-code;
representing each function as a graph of basic blocks; and
creating a GoG for all functions in the stripped binary, wherein nodes contain a graph of basic blocks of a function, and edges represent relationships between functions based on the cross-calling dependencies.

14. The system of claim 12, wherein converting the plurality of GoGs into a plurality of expressive representations comprises:
inputting the plurality of GoGs to a hierarchical graph learning pipeline comprising a control flow graph (CFG) embedding layer and a GoG embedding layer to produce the expressive representations.

15. The method of claim 14, the hierarchical graph learning pipeline further performing the steps of:
in the CFG embedding layer, using one or more graph convolutional network (GCN) layers to propagate features for each basic block of a function to produce an aggregated vectorized representation; and
in the GoG embedding layer, receiving the aggregated vectorized representation, incorporating calling and callee functions information into each function to produce the expressive representation of each function.

16. The method of claim 15, the non-transitory memory further comprising instructions that when executed by the computer processor cause the computer processor to:
train the ML model using the expressive representations of the functions in a contrastive function similarity learning process.

17. The system of claim 16, the non-transitory memory further comprising instructions that when executed by the computer processor cause the computer processor to:
on a condition that the expressive representation of two functions indicate that the two functions behave similarly, determining a missing symbol of one of the functions based on the function's embeddings.

18. The system of claim 13, wherein the decompiler is a Ghidra decompiler.

19. The system of claim 14, the non-transitory memory further comprising instructions that when executed by the computer processor cause the computer processor to:
implement the hierarchical graph learning pipeline as a data toolkit for a Ghidra reverse engineering tool.

20. The system of claim 12, the non-transitory memory further comprising instructions that when executed by the computer processor cause the computer processor to:
perform a software update of the stripped binary based in part of the discovered missing symbol.
